(19) United States
(12) Patent Application Publication
(10) Pub. No.: US 2003/0210442 A1
(43) Pub. Date: Nov. 13, 2003

(54) Adjustable optical mechanism

(76) Inventor: Thomas Sheng, Hsin Chu (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/280,560

(22) Filed: Oct. 28, 2002

(30) Foreign Application Priority Data
May 10, 2002 (TW) 091206658

(51) Int. Cl. H04N 1/04; H04N 1/46

(52) U.S. Cl. 358/532; 358/486

(57) ABSTRACT

An adjustable optical mechanism includes a carriage base, an adjusting board mounted on the carriage base, and a circuit board mounted on the adjusting board. An image sensor is mounted on the circuit board and corresponds to a lens mounted on the carriage base. Deforming the adjusting board and adjusting the position and tilt of the adjusting board relative to the carriage base, the position of the image sensor may be properly adjusted so as to obtain better image quality.

### FIELD OF THE INVENTION

The present invention relates to an optical mechanism, and in particular to the mechanism in which the position and the inclination of the image sensor may be finely adjusted.

### BACKGROUND OF THE INVENTION

A conventional optical mechanism in a scanner generally includes a carriage base, a lens and an image sensor. The image sensor such as CCD is fixed to a circuit board which is fixed to the carriage base so that the image sensor is located in correspondent to the lens.

The circuit board is moveable on the carriage base because elongate holes are defined in the circuit board and the inclination of the circuit board can also be adjusted. By this way, the correspondence between the lens and the image sensor meets the designer's intention. An assistance device such as a computer and an oscilloscope can be used to obtain the result of the correspondence between the image sensor and the lens.

The adjustments to the image sensor include an up and down adjustment and an inclination adjustment. These conventional adjustments cannot meet the requirement for providing high quality scanning images in the present market.

### SUMMARY OF THE INVENTION

The primary object of the present invention is to provide an adjustable optical mechanism which involves more degrees of freedom in multiple directions so that the worker may adjust the image sensor to its best position.

Another object of the present invention is to provide an adjustable optical mechanism which can be conveniently and finely adjusted.

In order to achieve the purposes mentioned above, a circuit board with an image sensor connected thereto is connected to an adjusting board. The image sensor can be adjusted to its best position by using the change of the relative position and the inclination between the adjusting board and the carriage base, the change of the relative position and inclination between the circuit board and the adjusting board, and the deformation of the adjusting board itself.

The present invention will become more obvious from the following description when taken in connection with the accompanying drawings which show, for purposes of illustration only, preferred embodiments in accordance with the present invention.

### BRIEF DESCRIPTION OF THE DRAWINGS

FIG. 1 shows the assembly of the present invention.

FIG. 2 is a perspective view of the adjusting board.

FIG. 3 is another perspective view to show the adjusting board.

FIG. 4 shows one of the adjustments.

FIG. 5 shows another one of the adjustments.

FIG. 6 shows yet another one of the adjustments.

FIG. 7 shows another embodiment of the adjustments.

FIG. 8 shows yet another adjustments of the present invention.

### DETAILED DESCRIPTION OF THE PREFERRED EMBODIMENTS

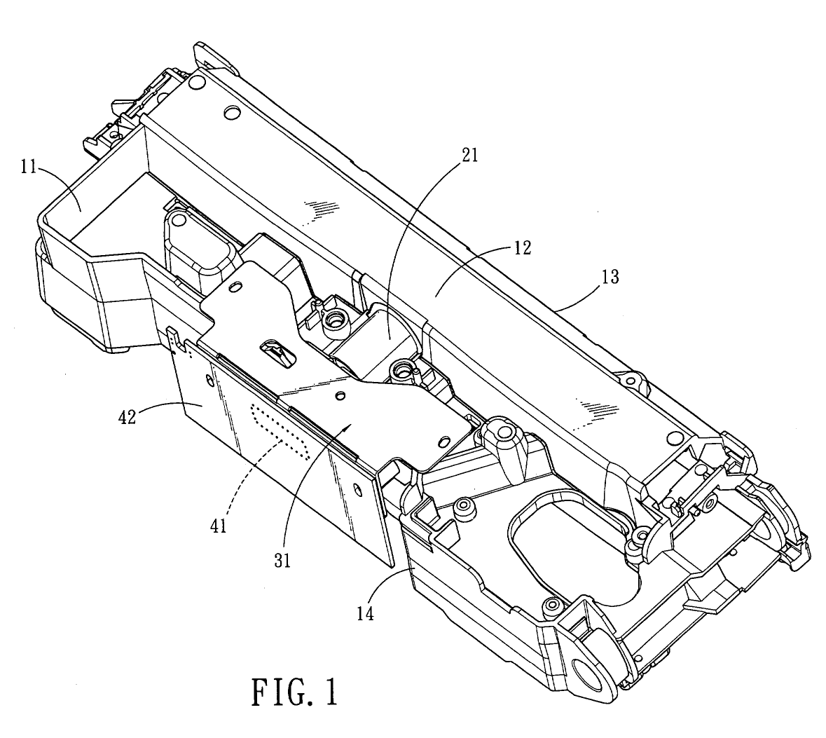

FIG. 1 shows the assembly of the present invention and discloses a carriage base 11, a lens 21, an adjusting board 31, a circuit board 42 and an image sensor 41.

A reflection mirror set 12 is installed on the first side 13 of the carriage base 11. The reflection mirror set 12 comprises at least one reflection mirror so as to receive and reflect the image information from the document. The lens 21 is placed on the carriage base 11 and receives the image information from the reflection mirror set 12.

In another embodiment, only the lens 21 is placed on the carriage base 11 and no reflection mirror set needs to be placed on the carriage base 11. The lens 21 on the carriage base 11 may receive the image information from the scanned document, or the carriage base 11 can be separated from the reflection mirror set.

The adjusting board 31 is adjustably mounted on a second side 14 of the carriage base 11 and located in correspondence with the lens 21. The image sensor 41 is mounted on the circuit board 42 which is adjustably mounted on the adjusting board 31, and the image sensor 41 is located in correspondence to the lens 21.

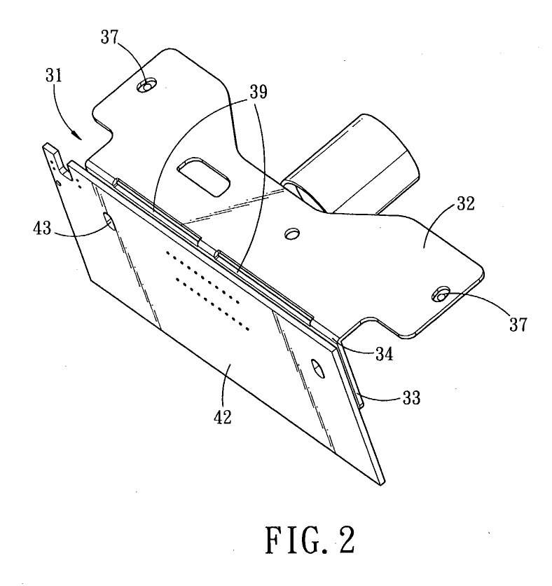

FIG. 2 is a perspective view of the adjusting board. The adjusting board 31 is an L-shaped board and includes a lateral portion composed of a first plate 32, and a longitudinal portion composed of a second plate 33. A connection portion 34 is formed at the conjunction of the two plates. Two elongate slots 39 are defined in the connection portion 34 so that the two plates may be deformed under pressure. Under design considerations, the two elongate slots 39 may be omitted, or the number of the elongate slots 39 may be reduced or increased. The first plate 32 and the circuit board 42 both have two holes 37 and 43.

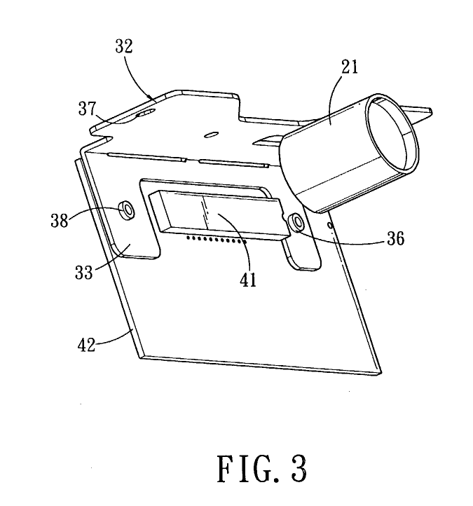

FIG. 3 is another perspective view to show the adjusting board. The second plate 33 has two rods 36 with a threaded hole 38. Screws (not shown) extend through the holes 43 in the circuit board 42 to fix the circuit board 42 onto the second plate 33. Before threading, the circuit board 42 can be moved up and down, or swung an angle relative to the second plate 33.

The image sensor 41 is fixed to the second plate 33 and located in correspondence to the lens 21.

The adjusting board 31 mentioned hereinabove has plastic deformability and is deformed by simply pressing or bending by fingers, which may also be a deformable metal plate.

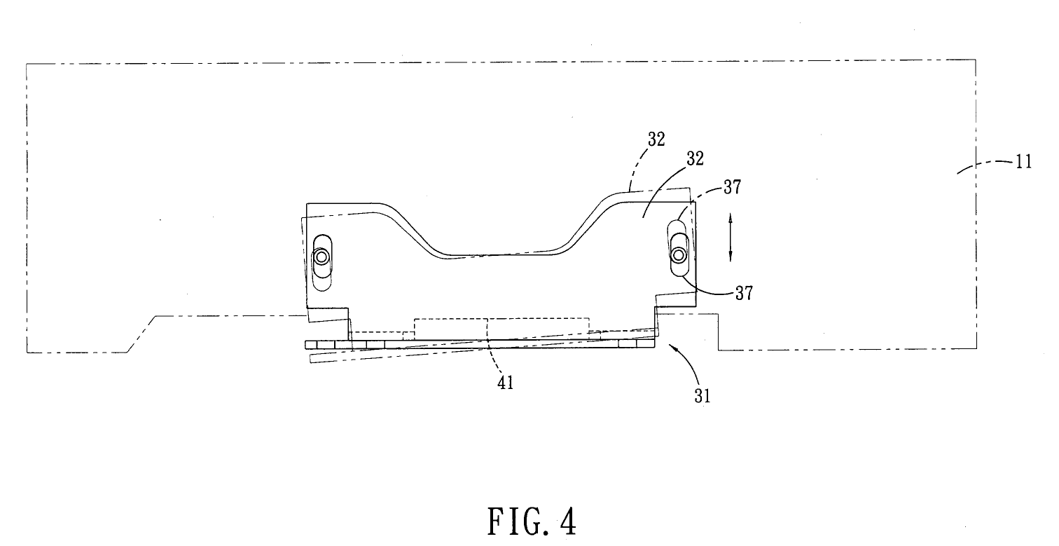

FIG. 4 shows one of the adjustments. The adjusting board 31 is fixed to the carriage base 11 by the first plate 32 which has holes 37 for the securing members (not shown) to extend, so that the adjusting board 31 can be moved forward and backward as shown in arrow heads without disconnecting the securing members from the holes 37. The adjusting board 31 can also be swung an angle as shown by dotted lines. The image sensor 41 on the adjusting board 31 can be preliminarily adjusted.

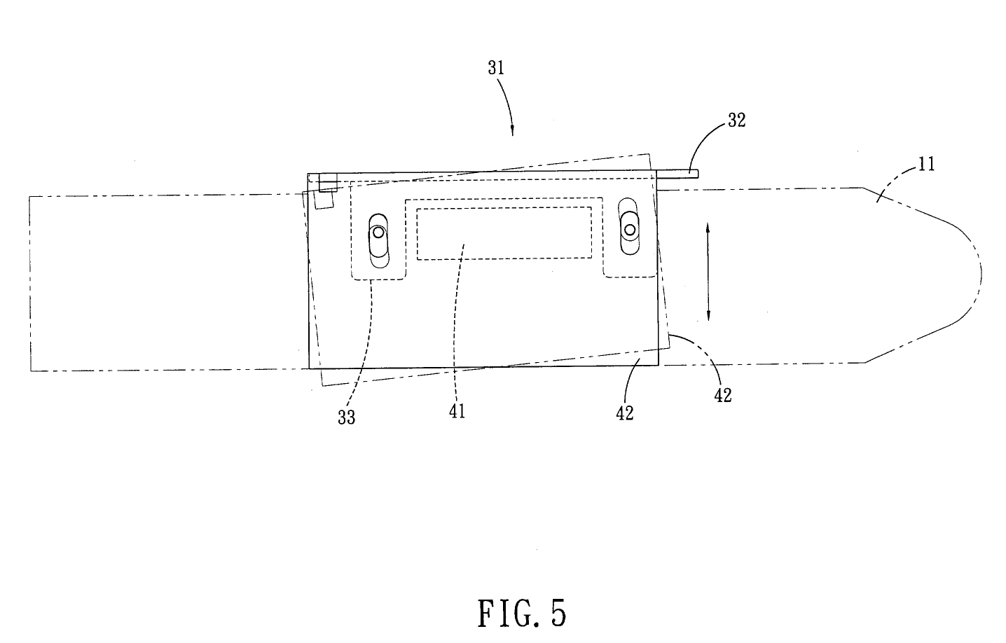

FIG. 5 shows another one of the adjustments. Due to the relative movement and swing between the second plate 33 and the circuit board 42, the circuit board 42 can be moved up and down as shown in arrow heads, or swung an angle as shown by dotted lines while the second plate 33 is fixed. By the adjustment described above, the circuit board 42 and the image sensor 41 on the second plate 33 on the adjusting board 31 may be further adjusted.

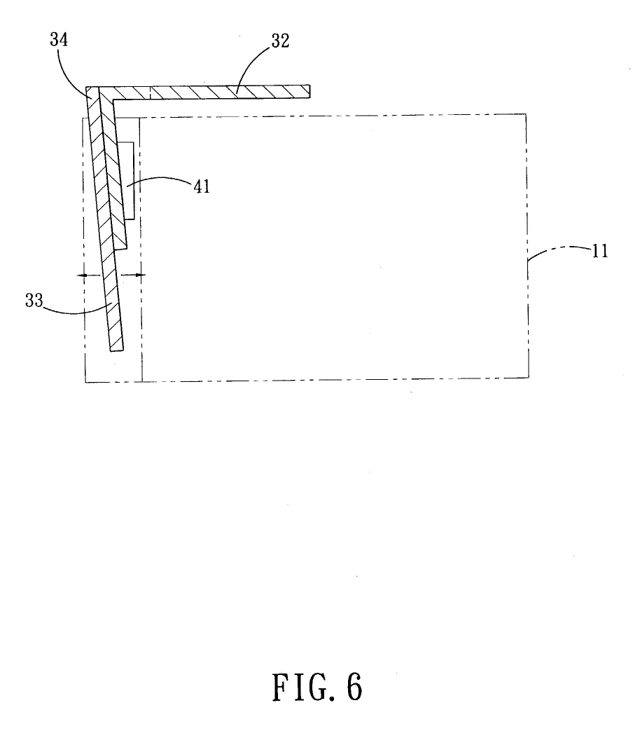

FIG. 6 shows yet another one of the adjustments. The second plate 33 and the connection portion 34 of the first plate 32 have plastic deformability, so that the second plate 33 or the circuit board 42 can be pressed and deformed when being adjusted. The image sensor 41 on the circuit board 42 may be shifted a distance or swung by an angle of inclination accordingly. By the adjustment, the image sensor is further adjusted and the worker may finely adjust the mechanism within a short period of time by the way of deformation.

In order to allow the worker to adjust the mechanism conveniently, the following embodiment can assist the worker to adjust the optical mechanism.

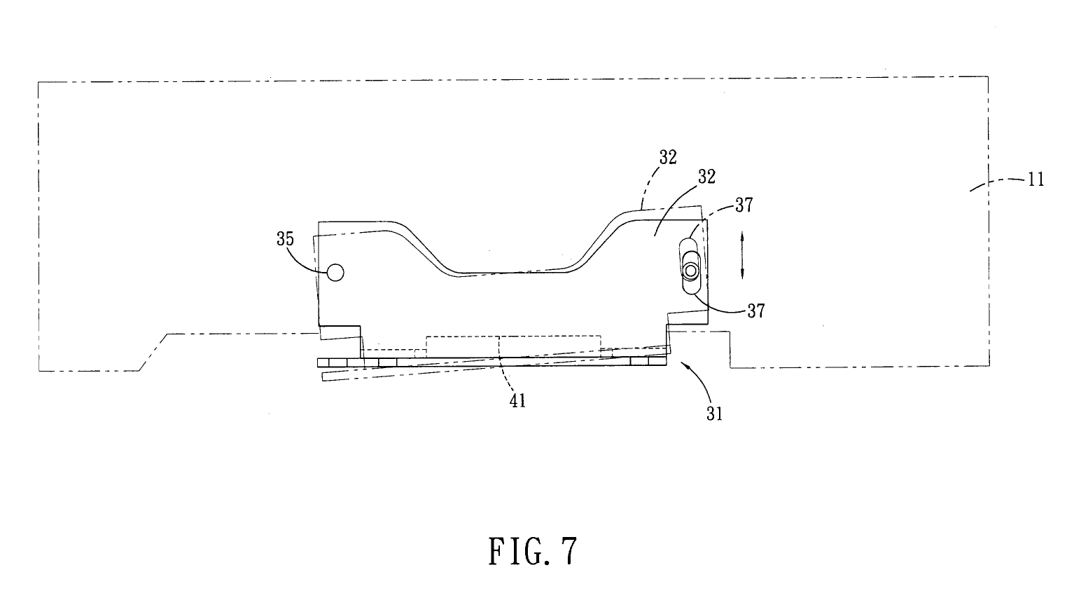

FIG. 7 shows another embodiment of the adjustments. The adjusting board 31 is fixed to the carriage base 11 by securing members and a hole 35, and an elongate hole 37 are defined in the first plate 32 so that the securing member may extend therethrough. By the adjustment described above, when the worker adjusts the adjusting board 31, the adjusting board 31 may be rotated about the securing member in the hole 35 and the other end of the adjusting board 31 is moved in the elongate hole 37. In this way, the adjusting trace of the adjusting board 31 is regular and this allows the worker to adjust the image sensor 41 to the optimum condition.

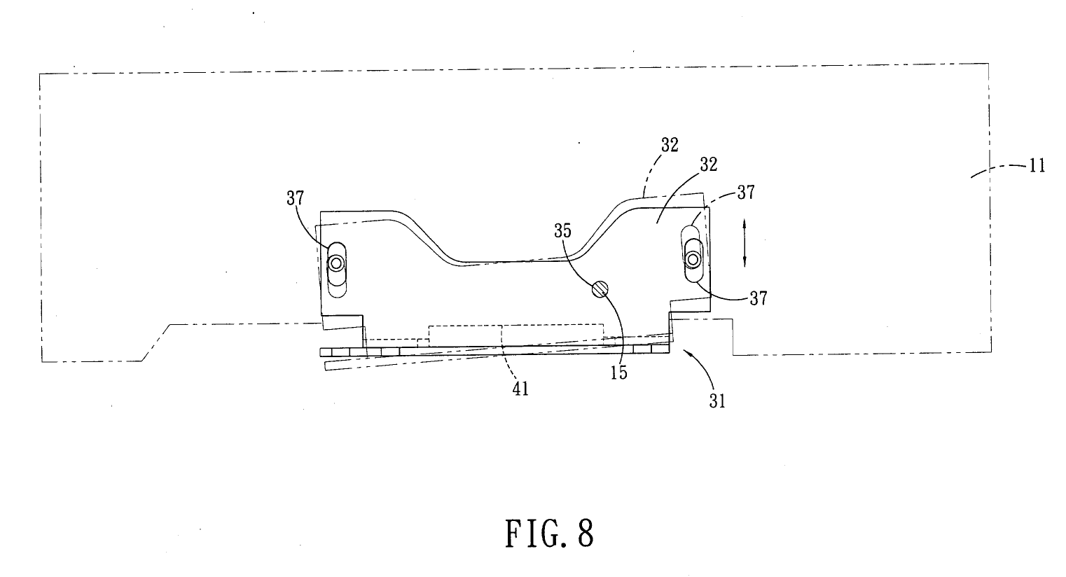

FIG. 8 shows yet another adjustments of the present invention. The adjusting board 31 is fixed to the carriage base 11 by securing members, and a hole 35 and two elongate holes 37 are defined through the first plate 32 of the adjusting board 31. The carriage base 11 has a pin 15 extending through the hole 35 and the securing members extend through the two elongate holes 37 to fix the adjusting board 31 to the carriage base 11. By the structure described above, when the worker adjusts the adjusting board 31, the adjusting board 31 may be rotated about the pin 15 and the two ends of the adjusting board 31 are moved in the two elongate holes 37. In this way, the adjusting trace of the adjusting board 31 is regular and this allows the worker to adjust the image sensor 41 to the optimum condition. It is to be noted that the positions of the pin 15 and the hole 35 can be any position that allows the adjusting board 31 to rotate about the pin 15, such as at one of the left and right ends of the image sensor 41.

The adjustment can be made by adjusting the adjusting board 31 or the first plate 32 depending on practical needs, or adjusting the second plate 33, or combination of the two types of adjustments. Multiple degrees of freedom are obtained by these adjustments so that the image sensor 41 can be adjusted to an optimum position to get the best quality of the image. Besides, the adjustment is simple, especially by deforming the second plate 33 by pressing it and this requires no extra positioning process and is convenient for the worker to proceed.

While we have shown and described the embodiments in accordance with the present invention, it should be clear to those skilled in the art that further embodiments may be made without departing from the scope of the present invention.

What is claimed is:

1. An adjustable optical mechanism, comprising:
a carriage base for at least one lens to be placed on;
an adjusting board which is adjustably mounted on the carriage base;
a circuit board which is adjustably mounted on the adjusting board; and
an image sensor mounted on the circuit board and located in correspondence with the lens on the carriage base.

2. The adjustable optical mechanism as claimed in claim 1, wherein the adjusting board is an L-shaped board and includes a lateral portion connected to the carriage base, and a longitudinal portion connected to the image sensor.

3. The adjustable optical mechanism as claimed in claim 2, wherein the adjusting board is plastically deformable so that the adjusting board may be adjusted.

4. The adjustable optical mechanism as claimed in claim 2, wherein the lateral portion is a first plate and the longitudinal portion is a second plate, and a connection portion is formed at a conjunction between the first plate and the second plate.

5. The adjustable optical mechanism as claimed in claim 4, wherein at least one elongate hole is formed in the connection portion for the adjusting board to be adjusted.
